(19) United States
(12) Patent Application Publication
(10) Pub. No.: US 2003/0015144 A1
(43) Pub. Date: Jan. 23, 2003

(54) Push-through pet food container and dispenser

(76) Inventors: Harold Bennett, St. Joseph, MO (US); Larry Gelfond, Los Angeles, CA (US); Patricia Akens, Pasadena, CA (US)

Correspondence Address: Bell, Boyd & Lloyd LLC, P.O. Box 1135, Chicago, IL, 60690-1135, US

(21) Appl. No.: 10/167,847

(22) Filed: Jun. 12, 2002

Related U.S. Application Data
(60) Provisional application No. 60/299,043, filed on Jun. 18, 2001.

(51) Int. Cl. A01K 1/10; A01K 5/00; A01K 39/00

(52) U.S. Cl. 119/61

(57) ABSTRACT

An improved pet food container for holding same and for providing and dispensing a single or multi-component pet food is provided. The container and dispenser includes a body that defines an interior including a first opening at a first end and a second opening at a second end. A moveable wall is located within the interior and is moveable from a first position to a second position. The container also includes an opposing wall, wherein a quantity of pet food is maintained between the moveable wall and the opposing wall.

### BACKGROUND OF THE INVENTION

The present invention relates generally to pet food. More particularly, the present invention relates to pet food containers and dispensers.

A variety of pet food products are available to consumers. These products range from meals providing complete nutritional support to snacks. Certain pet foods are further adapted to fight or control disease. Pet food products are available in a variety of shapes, sizes and forms. While nutrition and health are important factors, the pet foods should be palatable, so that the pet consumes the required amount necessary for proper nutrition. A pet owner will not repeatedly buy pet food or pet food snacks that the pet will not eat.

Generally, dry pet food is not as palatable as wet pet food. Many dogs and cats, being carnivores, prefer the taste of wet food. Canned or high moisture pet food products, containing meat and having a moisture content above fifty percent by weight, are typically more palatable than dry pet food.

However, dry pet food serves many purposes. Dry food is a highly nutritional form of pet food. The relatively low moisture content of dry pet food permits a higher degree of nutritional balancing of ingredients. Moreover, certain dry pet foods are designed to provide benefits to the dental hygiene of pets. In this regard, the action of biting and chewing dry pet products functions to remove tartar from the teeth of pets.

Dry pet food also provides other advantages. Dry pet food is typically less expensive than a similar quantity of wet pet food. The dry pet food also stays fresher for a longer period of time, which allows the pet owner to leave a portion of the dry pet food exposed to the pet for a longer period of time.

Wet pet food typically includes a meat product, such as beef, fowl, pork or fish, and must be more rigorously sealed from ambient air than dry pet food. Wet pet food is usually provided in a sealed metal can and in a portion suitable for one or two feedings. Leftover wet pet food should be refrigerated between feedings. Dry pet food can be provided in larger paper bags or plastic containers that contain a quantity of food that stays fresh at ambient temperatures for weeks or months.

Due to the containers in which it is housed, wet pet food typically requires external devices such as can openers and kitchen utensils to open, remove and serve the wet food. The process of serving wet pet food can create a mess in a consumer's home and becomes cumbersome when attempted away from the home.

A need therefore exists to provide a wet pet food container that is sanitary, convenient to use and that does not dirty utensils in the process of removing the pet food contained therein. There is also a need for this container to hold a combination of dry pet food and palatability enhancing wet pet food.

### SUMMARY OF THE INVENTION

The present invention provides an improved pet food container and dispenser. More specifically, the present invention provides a pet food container and method for providing and dispensing the pet food that allows a consumer to dispense the pet food by merely pressing one end of the container, thereby dispensing pet food from an opposing end of the container.

To this end, in an embodiment of the present invention, a pet food container and dispenser is provided. The container and dispenser includes a body that defines an interior including a first opening at a first end and a second opening at a second end. A moveable wall is moveable from a first position to a second position. The container also includes an opposing wall, wherein a quantity of pet food is maintained between the moveable wall and the opposing wall.

In an embodiment, the body is cylindrical.

In an embodiment, the moveable wall slides against an inner surface of the body.

In an embodiment, the moveable wall hingedly attaches to the body.

In an embodiment, the opposing wall hingedly attaches to the body.

In an embodiment, the container and dispenser includes a seal between the opposing wall and the body. The seal can be selected from the group consisting of an induction seal, an adhesive seal and a plastic to plastic seal.

In an embodiment, the container and dispenser includes a member that extends from the moveable wall to the opposing wall.

In an embodiment, the container is constructed so that when the consumer presses and moves the moveable wall, it causes the opposing wall to be dislodged from the body.

In an embodiment, the container and dispenser includes a plurality of compartments that separate a first pet food component from a second pet food component.

In another embodiment of the present invention, a pet food container and dispenser is provided. The container and dispenser includes a body that defines an interior including a first opening at a first end and a second opening at a second end. A first wall is located within the interior and moveable in a first end to second end direction. A second wall is located within the interior and moveable in a second end to first end direction. A quantity of pet food is maintained between the first and second moveable walls.

In an embodiment, the container and dispenser includes a first seal that covers and seals the first opening and a second seal that covers and seals the second opening.

In an embodiment, the first and second seals are foils.

In an embodiment, the first and second walls are cardboard.

In an embodiment, the container and dispenser includes a seal between the first wall and the body and a seal between the second wall and the body.

In yet another embodiment of the invention, a pet food-dispensing container is provided, the container comprising a body defining an interior for containing pet food, the body having first and second opposed ends, each end including an opening and closure means.

In an embodiment, the closure means comprises a moveable wall. The moveable wall may be moveable into the interior of the container body.

In an embodiment, the closure means comprises sealing means.

In a further embodiment, a method for providing a pet food meal is provided. The method includes the step of providing a container that includes an end with a moveable wall, an end with an opposing wall and pet food maintained between the moveable wall and the opposing wall. The method also includes the step of pressing and moving the moveable wall so that the moveable wall forces a quantity of the pet food to be dispensed from the container.

In an embodiment, the method includes removing the end wall first and then pressing and moving the moveable wall so that the moveable wall forces the quantity of first pet food from the container.

In an embodiment, the method includes pressing and moving the moveable wall and forcing the pet food to rupture a seal so that the pet food can be dispensed from the container.

In an embodiment, the pet food has a plurality of components. The multi-component pet food is maintained between the moveable wall and the opposing wall so that pressing and moving the moveable wall forces the multi-component pet food from the container.

In an embodiment, the container defines a plurality of compartments that separate a plurality of pet food components. The compartments and components are maintained between the moveable wall and the opposing wall so that pressing and moving the dispensing wall forces the components from the container.

An advantage of the present invention is to provide improved pet food containers.

Another advantage of the present invention is to provide a pet food container that holds and dispenses wet pet food.

Furthermore, an advantage of the present invention is to provide an improved pet food including a dry pet food component and a wet pet food component.

Moreover, an advantage of the present invention is to provide an improved pet food container that individually stores and dispenses a dry pet food component and a wet pet food component.

Still another advantage of the present invention is to provide an improved pet food container that stores a dry pet food component and a wet pet food component and dispenses the pet food.

Still further, an advantage of the present invention is to provide a convenient method of providing pet food products to a consumer that does not require a separate utensil to remove wet pet food.

Further, an advantage of the present invention is to provide a more palatable dry pet food.

Additional features and advantages of the present invention will be described in and apparent from the detailed description of the presently preferred embodiments.

### BRIEF DESCRIPTION OF THE FIGURES

FIG. 1 is a perspective view of an embodiment of the pet food container and dispenser of the present invention.

FIG. 2 is a sectioned elevation view of the embodiment of the pet food container and dispenser of FIG. 1.

FIG. 3 is a sectioned elevation view of a further embodiment of the pet food container and dispenser of the present invention having a hinged wall.

FIG. 4 is a sectioned elevation view of a further embodiment of the pet food container and dispenser of the present invention having a member extending between end walls.

FIG. 5 is a sectioned elevation view of another embodiment of the pet food container and dispenser of the present invention having one non-translating wall.

FIG. 6 is a sectioned elevation view of another embodiment of the pet food container and dispenser of the present invention having two moveable, sealed walls.

FIG. 7 is a sectioned elevation view of a further embodiment of the pet food container and dispenser of the present invention having one moveable, sealed wall and one non-sealed wall.

FIG. 8 is a sectioned elevation view of the embodiment of the pet food container and dispenser of FIG. 7 dispensing a multi-component pet food.

FIG. 9 is a sectioned elevation view of another embodiment of the pet food container and dispenser of the present invention having multiple pet food component compartments.

FIG. 10 is a sectioned elevation view of another embodiment of the pet food container and dispenser of the present invention having multiple pet food component compartments.

### DETAILED DESCRIPTION OF THE PRESENTLY PREFERRED EMBODIMENTS

The present invention relates to a pet food-dispensing container. The container has opposed ends having an opening at each. To retain the pet food within the interior of the container until ready for dispensing, the ends are equipped with suitable closures to seal in the contents. At least one of the closures defines a moveable wall that, when caused to move in relation to the contents, results in the transfer of force to the other closure to cause it to open and being the dispensing of the food.

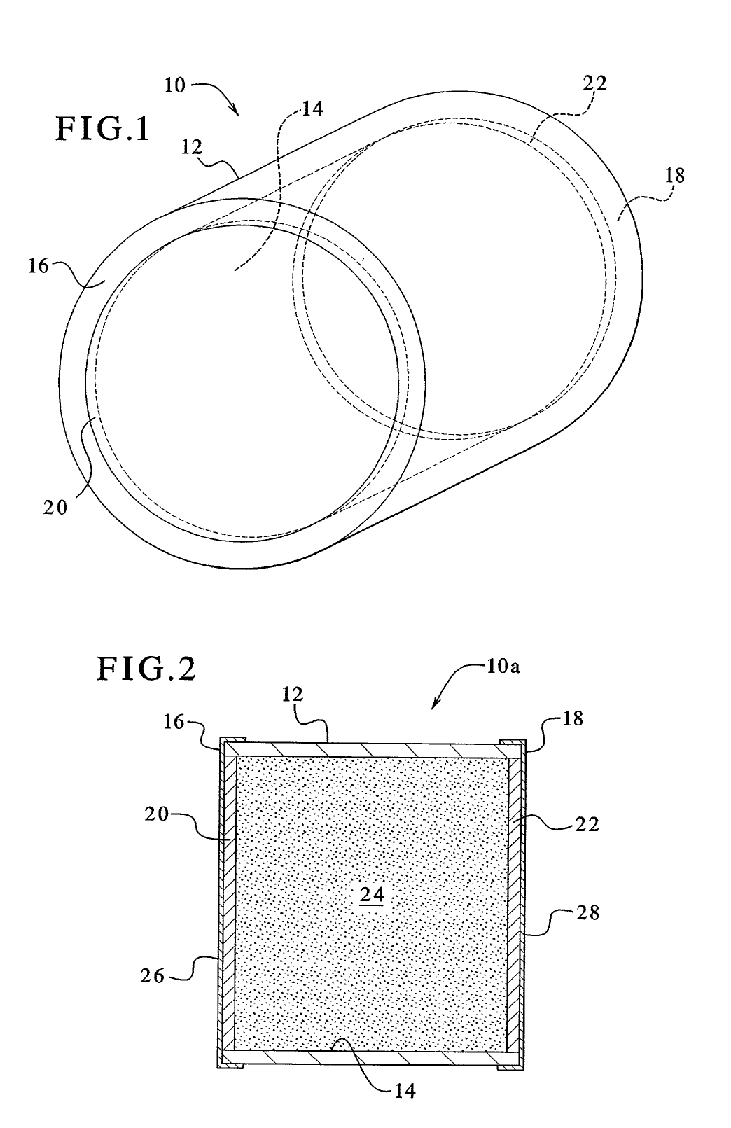

Referring now to FIG. 1, a general embodiment of a pet food container and dispenser 10 (hereinafter referred to as “container” 10) of the present invention is illustrated. The container 10 includes a body 12 having an inner surface 14 that defines an interior space or cavity. The body 12 also defines openings on a first end 16 of the body and on a second end 18 of the body 12. A first wall 20 covers a portion, substantially all or all of the opening (illustrated covering all) of the first end 16. A second wall 22 covers a portion, substantially all or all of the opening of the second end 18. The interior defined by the inner surface 14 of the body 12 holds a pet food product having one or more components. The first and second walls 20 and 22 initially constrain the pet food from leaving the interior.

As illustrated, the body 12 in an embodiment is round cylindrical. Of course, the body may be any shape, e.g., square or rectangular. However, it is believed a cylindrical shape is adept at withstanding pressure from within the container 10 exerted by the pet food, as illustrated below. The cylindrical shape is also believed to be desirable as it can withstand forces applied during packaging and shipping. The body 12 can be made of a variety of materials, e.g., a rigid material, such as metal, or a semi-rigid rigid material, such as cardboard or plastic. Either of these types of materials for the body 12 can be provided in combination with walls 20 and 22, either or both of which may be constructed from semi-rigid or rigid materials.

Referring now to FIG. 2, a section view of an embodiment of the container 10a is illustrated. The container 10a includes the body 12 having the inner wall 14 that defines an interior holding a pet food product 24 of one or more components. The first and second walls 20 and 22 cover the openings at ends 16 and 18 of the body 12, respectively, and maintain the product 24 within the body 12. In this embodiment, the walls 20 and 22 are moveable and may or may not form a seal with the inner wall 14 of the body. The moveable walls 20 and 22 in one embodiment extend to, contact and slide against the inner wall 14, as illustrated. Therefore the walls apply a force to the entire area, e.g., circular area of the product 24, when a consumer presses or pushes one of the walls 20 and 22. If the product 24 is viscous enough so that it sticks together and moves as a bulk mass, the moveable walls 20 or 22 may cover a portion of or most all of the openings at ends 16 and 18. In either case, the container 10a is preferably adapted to remove as much product 24 as possible from within the body 12.

In the embodiment illustrated in FIG. 2, the container 10a preferably includes a first seal 26 that seals the opening of the first end 16 and a second seal 28 that seals the opening of the second end 18. The seals 26 and 28 in one embodiment are heat or induction foils that adhere to the body 12. In another embodiment, the seals 26 and 28 adhere to the body 12 through the use of a suitable adhesive. The seals 26 and 28 may be thin plastic, paper/thin cardboard that is waxed or otherwise has a bonded layer of impermeable film, or thin metal.

In the embodiment illustrated in FIG. 2, the seals 26 and 28 wrap around and seal to the outer surface of the body 12. However, if desired, the seals 26 and 28 can adhere or seal to the ends 16 and 18, respectively, e.g., through the use of an adhesive. The seals may be perforated or otherwise predisposed to rupture in a certain place or in a certain pattern.

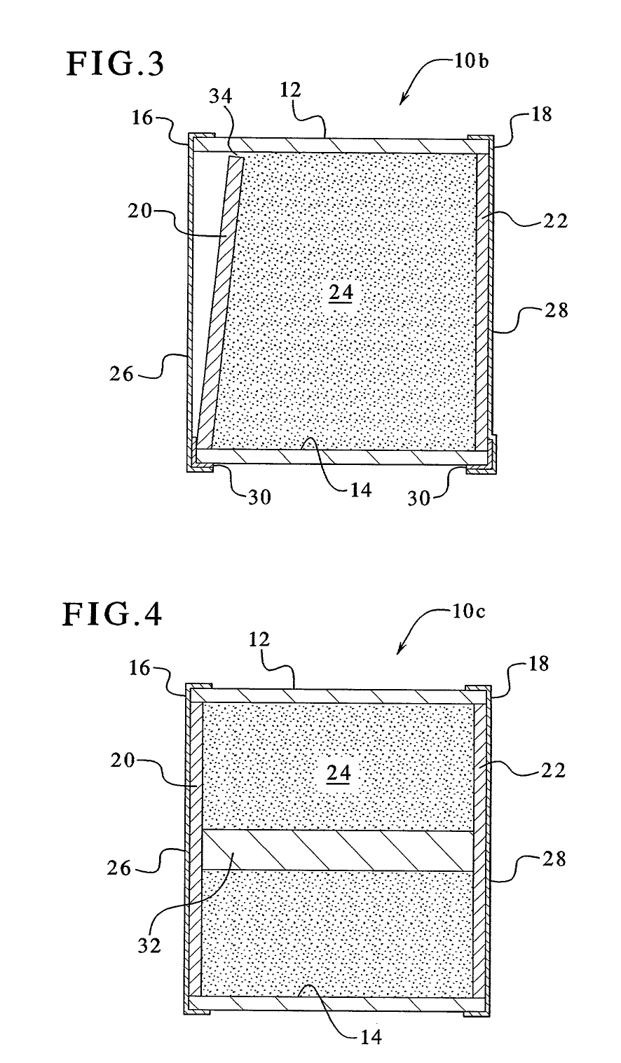

Referring now to FIG. 3, a section view of an embodiment of the container 10b is illustrated. The container 10b is substantially the same as container 10a and includes the body 12 having the inner wall 14 that defines an interior holding at least one food product 24. First and second walls 20 and 22 cover the openings at ends 16 and 18 of the body 12, respectively, and maintain the product 24 within the body 12. Container 10b also can include the seals 26 and 28 described above.

In addition, in the embodiment of the container 10b, one or both of the first and second walls 20 and 22 are attached to the body 12 via a hinge 30. For purposes of illustration, the wall 20 is shown pivoting towards the interior of the body 12 (i.e., pressurizing pet food 24) with the seal 26 intact. Seal 26 would have to be broken or removed or at least sufficiently inwardly deformed to displace the wall 20 as illustrated. Preferably, seal 28 is of a deformable plastic material having sufficient rupture resistance not to break and risk spillage of the contents on to the exterior of wall 20 as it is being pushed inwards. Further, the product 24, being largely incompressible, would likely have forced the seal 28 to rupture and the hinged wall 22 to open if the wall 20 is displaced as illustrated. Thus, in a preferred embodiment, the rupture resistance of the seals 26 and 28 may differ, so that the material of seal 28 is less rupture resistant than that of seal 26. The hinge 30 may be constructed of thin plastic, paper/thin cardboard that is waxed or otherwise has a bonded layer of impermeable film, or thin metal, which is tear resistant.

Referring now to FIG. 4, a section view of an embodiment of the container 10c is illustrated. The container 10c is substantially the same as container 10a and includes the body 12 having the inner wall 14 that defines an interior holding a food product 24 of one or more components. First and second walls 20 and 22 cover the openings at ends 16 and 18 of the body 12, respectively, and maintain the product 24 within the body 12. The container 10c also preferably includes the seals 26 and 28 described above.

In addition, the container 10c includes a rigid member 32 extending between and connected to at least one of the walls 20 and 22. The member 32 may be constructed of any type of rigid, lightweight material including plastic tubing or other plastic structure or cardboard that is waxed or otherwise has a bonded layer of moisture impermeable film. The member 32 attaches to the walls 20 and 22 via an adhesive that is suitable for contacting the product 24 or by press fitting into grooves or cutouts (not illustrated) in the walls 20 and 22.

The container 10c may have any number of structural members 32 that connect the walls 20 and 22 to form a rigid structure on the interior of the body 12. This structure carries the product 24 with it, rather than compressing the product 24 between the walls 20 and 22, so that the product 24 is under less pressure. The container 10c is therefore suited for a product 24 that tends to splatter when one of the seals 26 or 28 is ruptured or when one of the walls 20 or 22 is dislodged from the body 12.

Each of the containers 10a, 10b and 10c operate in a similar manner and each may be adapted to dispense product in a number of ways. The following methods of dispensing product therefore apply to each of the containers 10a, 10b and 10c.

In one method, a consumer peels off both seals 26 and 28 and pushes one of the walls 20 or 22. Whichever wall the consumer engages (“engaged wall”) directs a force onto the product 24, which pressurizes the product 24, whereby the product 24 in turn exerts force on the opposing wall. For each of the containers 10a, 10b and 10c, when the engaged wall slides within the interior of the body 12, it pushes the product 24 with it. The opposing wall is also dislodged either by the product 24 or the member 32 (FIG. 4) away from the body, exposing the product 24 to ambient conditions. As the engaged wall continues to be pushed and moved, the product 24 is dispensed from the body 12.

Depending upon the viscosity, consistency and constituency (i.e., one component or a combination of components) of the product 24, the weight of the portion of product 24 that has been dispensed from the body may pull the remainder of the product 24 out of the body 12. Or, a less viscous product may run out of the body 12. Otherwise, the consumer may need to push one of the walls 20 or 22 (i.e., in opposite directions) substantially the entire length of the inner wall 14 to remove all of the product 24.

In another method, a consumer ruptures one or both of the seals. The consumer may engage and rupture one of the seals inwardly by pushing and moving one of the walls 20 or 22 until the seal 26 or 28, adjacent to the engaged wall, deforms to the point of rupture. For each of the containers 10a, 10b and 10c, the opposing wall, when moved by either the product 24 or the member 32, exerts an outwardly directed force on the adjacent seal. Eventually, this seal also deforms to the point of rupture. As indicated above, one or both of the seals 26 and 28 may be perforated or otherwise predisposed to rupture in a certain predetermined place pattern.

When the consumer presses one of the walls 20 or 22 of the hinged container 10c, an ever-increasing gap 34 of product 24 that is not directly contacted by the wall is created. This embodiment, therefore, may be limited to higher viscosity products 24 that tend to clump or move in a mass, that is, tend not to run through the gap 34 and onto the consumer's hand.

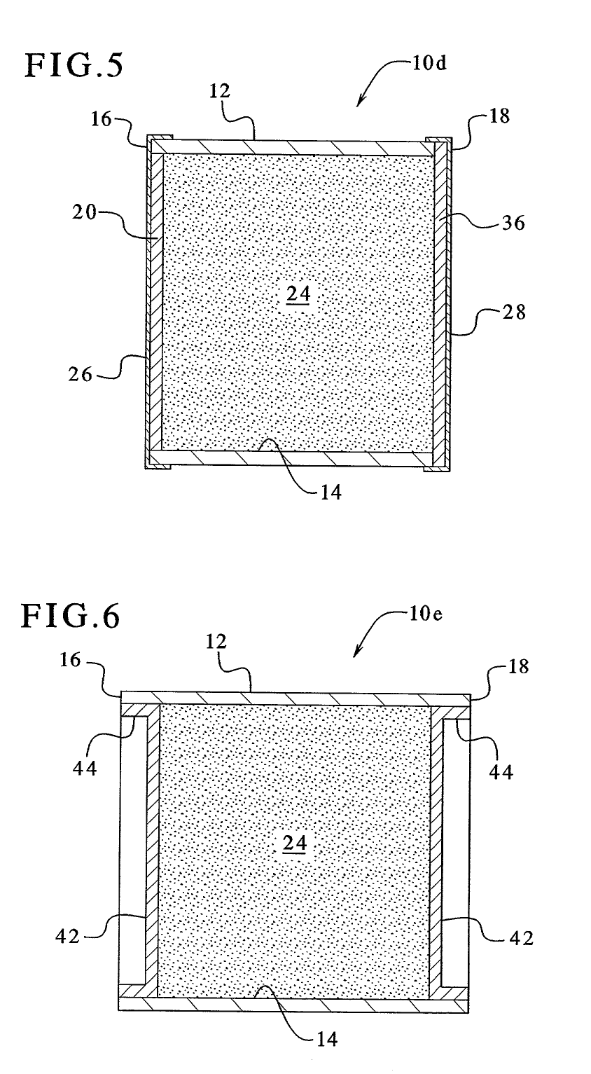

Referring now to FIG. 5, a section view of an embodiment of the container 10d is illustrated. The container 10d is substantially the same as container 10a and includes the body 12 having the inner wall 14 and ends 16 and 18, which define an interior that holds a food product 24 of at least one component. Container 10d includes the first moveable wall 20 and a second wall 36, which cannot move within the interior of the body 12. The wall 36 covers one the openings of the body 12, however, the consumer cannot move the wall 36 within the interior of body 12 to dispense the product 24. The container 10d illustrates an embodiment wherein the consumer can only translate one wall (wall 20) in one direction. The container 10d may further be adapted so that the wall 20 is hinged, as disclosed in connection with FIG. 3, or so that a member 32 extends between and attaches to at least one of the walls 20 and 36, as disclosed in connection with FIG. 4.

Although not illustrated, the packaging of each of the containers 10a through 10d can contain suitable indicia and instructions that direct the consumer as to the proper end to engage and whether to peel off or rupture the seals 26 and 28. Depending on the viscosity of the product 24, the packaging may need to have special instructions, such as holding the container so that the product 24 begins to dispense upwardly and then tipping the opened end to face downwardly towards a suitable pet food dish to dispense the product 24.

In another embodiment contemplated by the present invention, even though the wall 36 of container 10d cannot translate, it can flex. In this embodiment, the wall 36 is made of a flexible material, such as flexible plastic, but as described above, does not translate within the body 12. When the consumer presses the wall 36, however, wall 36 flexes and deforms in its middle so that either: (i) the product 24 is pressurized enough to pop the seal 26 and dispense the wall 20 or (ii) a member 32 (as in FIG. 4) coupled to the wall 36 and abutting but not coupled to the wall 20 moves enough to pop the seal 26 and dispense the wall 20. Since the wall 36 does not translate through the interior of the body 12, the opposing wall 20 preferably dislodges from the body 12 to allow product 24 to be dispensed. Therefore, in this embodiment, the wall 20 cannot be fixedly connected to the member 32. In either case, the consumer can alternatively remove the seal 26 before pressing the wall 36.

In this embodiment, the wall 36 can be formed integrally with or otherwise be permanently attached to the body 12 to eliminate the need for a second seal 28. In such a case, the product 24 is of such a viscosity that air flows around and replaces the dispensing product 24, through the opening at end 16 and into the interior of the body 12. Alternatively, this embodiment includes the second seal 28 and one or more air inlet holes (not illustrated) formed in the wall 36. In this implementation, the consumer removes the seal 28, presses and deforms the wall 36 and pops the wall 20 and/or seal 26, wherein displacement air enters the inlet holes from the backside of the dispensing product 24.

In an embodiment, it should be noted that the walls can be connected. In such a structure a pull member or ring will be provided to allow one to pull out the walls and pet food.

Referring now to FIG. 6 a section view of an embodiment of the container 10e is illustrated. The container 10e is similar to the above described containers and includes the body 12 having the inner wall 14 and ends 16 and 18, which define an interior that holds at least one food product 24. Instead of including separate seals, however, the walls 40 and 42 each seal to the body 12. In the illustrated embodiment, the walls 40 and 42 each seal directly to the inner surface 14 of the body 12. In other embodiments, walls 40 and 42 may be adapted to seal to other structural components extending inwardly from the inner wall 14 or the ends 16 and 18. That is, the walls 40 and 42 may cover a portion of, substantially all or all of the openings of the first end 16 and second end 18. For purposes of description and not limitation, the seal is illustrated existing between the walls 40 and 42 and the inner wall 14.

The seals between the walls 40 and 42 and the inner wall 14 may be induction or heat seals. The seals may otherwise employ an adhesive sealant suitable for contacting pet food, or the seals may be plastic to plastic seals. If a plastic to plastic seal is used, the walls 40 and 42 are in an embodiment plastic and the body is either plastic or lined with plastic. The walls 40 and 42 in an embodiment include a perpendicularly extending flange 44 about their perimeters to provide a larger sealing surface. The flanges 44 are illustrated as extending outwardly from the walls 40 and 42, which exposes the flanges 44 so that they may be heated, etc. to form the seal. Otherwise, mechanically press-fit seals enable the flanges 44 to face inwardly from the walls 40 and 42, which allows for a smaller sized package for the same product 24 quantity.

Dispensing product 24 from the container 10e may take place in either direction when the consumer engages and presses either the sealed wall 40 or the sealed wall 42. When the consumer presses either wall 40 or 42, it moves so that either: (i) the product 24 becomes pressurized and in turn dislodges the opposing sealed wall or (ii) a member 32 (FIG. 4) coupled to at least one of the walls 40 and 42 dislodges the opposing wall. Once the opposing wall is dislodged, the product 24 is exposed to ambient conditions and either spills out, falls out under its own weight or is pushed out via one of the moveably sealed walls 40 or 42.

In an embodiment, the sealable walls 40 and 42 may be resealed if the consumer does not desire to dispense the entire quantity of the product 40 or 42. The consumer slides the flange 44 of the dispensed wall 40 or 42 back into contact with the inner wall 14. The replaced seal may or may not have the integrity of the originally packaged (e.g., heat shrunk) seal, however, the resealed container 10e is substantially air-tight and also lessens the mess from a spill. Also, the volume of air in the container headspace is substantially eliminated, assisting thereby in preserving the remaining contents.

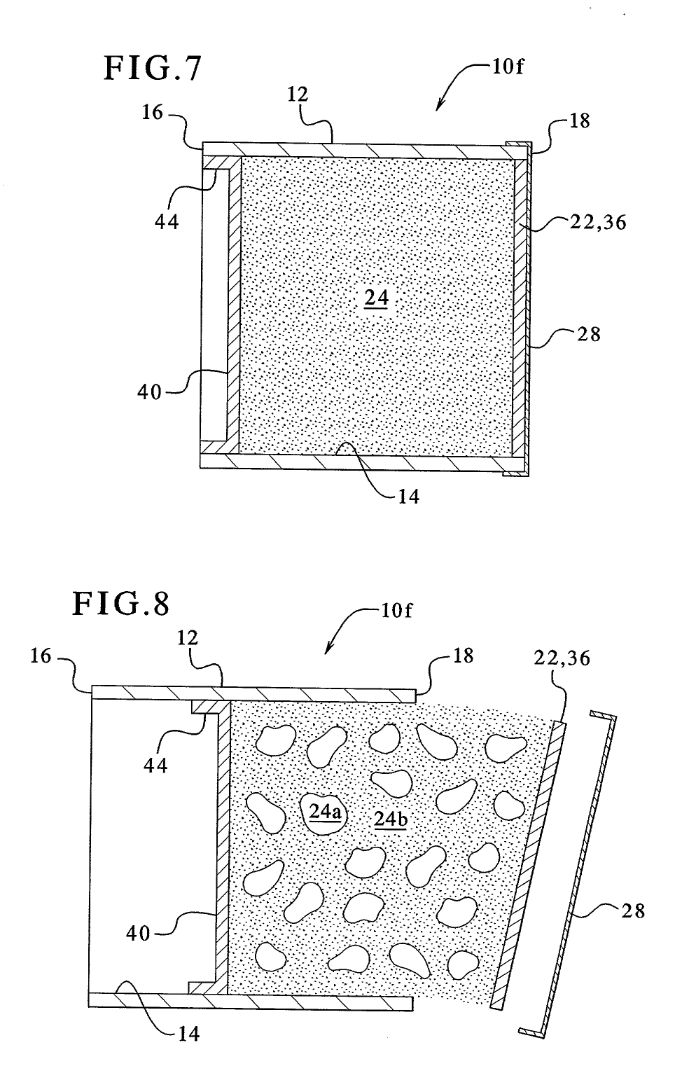

Referring now to FIG. 7, a section view of an embodiment of the container 10f is illustrated. The container 10f is substantially the same as container 10e and includes the body 12 having the inner wall 14 and ends 16 and 18, which define an interior that holds a food product 24 having at least one component. Container 10f includes one moveably sealed wall 40 and either: (i) a moveable wall 22 (FIGS. 2 to 4) or (ii) a non-translating wall 36 (FIG. 5). If the wall 22 is provided, it may be hinged via a hinge 30 (FIG. 4). The member 32 may also be provided with either the wall 22 or the non-translating wall 36. In this embodiment, if the member 32 is provided in combination with the integrally formed, non-translating wall 36, it couples to the wall 36 and abutts but does not couple to the sealed wall 40, so that the sealed wall 40 can be dislodged. The second seal 28 may or may not be provided with the integrally formed wall 36, as described above in connection with FIG. 5. The product 24 may be dispensed in either direction as described in the numerous embodiments herein disclosed.

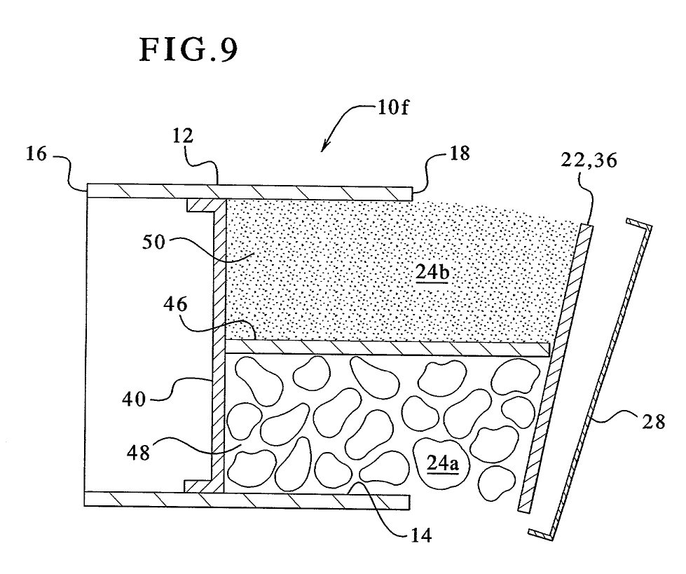

Referring now to FIGS. 8 and 9, the dispensing of product from the body 12 of the container is illustrated. These sectional figures illustrate two components 24a and 24b, however, any number of components may be provided with any of the container embodiments herein disclosed.

The container 10f includes a nutritionally balanced pet food meal. The product 24 heretofore described is preferably wet pet food. To reap the many benefits of dry pet food and to make the dry pet food more palatable, dry food in an embodiment is mixed as a component with a wet pet food component. The dry pet food component in an embodiment includes partially dried gelled chunks. In an embodiment the dry food includes kibbles, such as those disclosed in U.S. patent application Ser. No. 09/483,328, assigned to the assignee of this invention, the teachings of which are incorporated herein by reference.

The dry food/wet food mix is one combination of pet food components. Other combinations include semi-dry pet food in combination with wet pet food or dry, semidry or wet pet food in combination with a gravy or other flavor enhancer. The wet pet food can be shredded, diced or be prepared as a paste. The dry pet food can likewise be provided in a variety of shapes and sizes. These different pet foods have varying viscosities and in combination may produce an overall product having a non-homogeneous viscosity, density, moisture content, etc. For purposes of describing FIGS. 8 and 9, the product components 24a and 24b can each be any of the different pet foods herein described.

In FIG. 8, the pet food components 24a and 24b are packaged pre-mixed and dispensed accordingly. In an embodiment, a dry, semi-dry or chunky wet pet food component 24a is initially placed into the body 12, which has been sealed on one end 16 or 18. Gravy, wet pet food or any other less viscous component 24b is then added to fill the body 12. The gravy in an embodiment includes functional ingredients, such as targeted nutrients or digestibility enhancing agents, such as probiotic microorganisms or their moieties (e.g., from supernatants of their cultures). The remaining open end is sealed, whereby the container 10f undergoes a retort process to sterilize the contents. Alternatively, if either of the components 24a or 24b has live probiotic microorganisms, the container 10f is sterilized, and filled with suitably sterilized components 24a and 24b before the probiotic component is added. The container may then be sealed.

In FIG. 9, a divider plate 46 creates compartments 48 and 50 within the interior defined by the inner wall 14. The compartments 48 and 50 house separate pet food components 24a and 24b, respectively. The divider plate 46 in the illustrated embodiment extends axially across and may seal to the inside diameter or inside width of the body 12, to separate component 24a from 24b. A plurality of divider plates 46 may be integrally or separately attached to create a plurality of axially directed compartments that separate a plurality of components. The divider plate(s) 46 in another embodiment perform(s) the function of or is/are integrally or separately attached to the member 32 (FIG. 4).

In this illustrated embodiment, the pet food components 24a and 24b are dispensed at the same time. In an embodiment, the compartment 48 includes a dry or semi-dry food component 24a that is tightly packed and resistant to fragmentation under pressure. The compartment 50 includes a less viscous and substantially flowable component 24b, such as gravy, for addition to the dry or semidry component 24a. In this case, to seal the gravy, the plate 46 may be integrally or separately attached to the moveable walls and form a moveable seal with the inner wall 14.

In another embodiment (not illustrated), one or more divider plates are stacked generally radially, for example to be substantially parallel to the walls 40, 22 or 36, so that the pet food components 24a and 24b are dispensed at different times, e.g., dry, semi-dry or wet chunks 24a followed by a gravy or liquid component 24b. In an embodiment, the parallel divider plate(s) is/are integrally combined with or separately attached to the member 32.

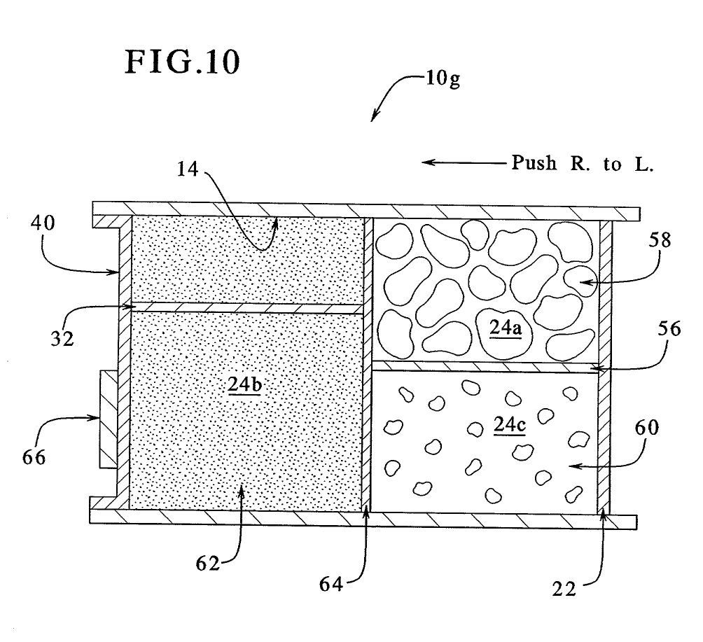

In a further embodiment, radially disposed dividers are combined with axially directed dividers to provide a container having the capacity to dispense different food items simultaneously, as well as successively in a predetermined and controllable manner. Such a container would thus comprise at least three internal chambers. An example is illustrated in FIG. 10, where a divider plate 56 creates compartments 58 and 60 within the interior defined by the inner wall 14. The compartments 58 and 60 house separate pet food components 24b and 24c, respectively. The divider 56 in the illustrated embodiment extends axially but is offset from the central axis to provide compartment 58 of smaller volume than compartment 60. Compartment 60 may, for example, contain a plurality of dry kibbles and compartment 58 a quantity of a dried powder containing probiotic micro-organisms. Compartment 62, defined by radial separating plate 64, houses a loaf-type wet pet food 24a.

Exterior moveable wall 40 is connected to radial divider 64 by the connecting rod 32. When pull-ring 66, located on moveable wall 40 is drawn out and the outward pulling force is exerted on wall 40, wall 40 is outwardly displaced, pulling divider 64 and the assembly constituted by attached axial divider 56 and opposed end wall 22 with it, together with the contents of the respective chambers 58, 60 and 62. Hence, the loaf product 24a is deposited into a waiting receptacle (not illustrated), followed by kibbles 24c and powder 24b, the latter two coinciding at least in part. The resulting meal is thus a combination of different textures. It is believed that combinations such as these help in overcoming taste fatigue amongst pets.

It should be understood that various changes and modifications to the presently preferred embodiments described herein will be apparent to those skilled in the art. Such changes and modifications may be made without departing from the spirit and scope of the present invention and without diminishing its attendant advantages.

We claim:

1. A pet food container and dispenser comprising:
a body defining an interior including a first opening at a first end and a second opening at a second end;
a moveable wall located to be moveable from a first position to a second position; and
an opposing wall located at an end of the body, wherein a quantity of pet food is maintained between the moveable wall and the opposing wall.

2. The container and dispenser of claim 1, wherein the body is cylindrical.

3. The container and dispenser of claim 1, wherein the moveable wall slides against an inner surface of the body.

4. The container and dispenser of claim 1, wherein the moveable wall hingedly attaches to the body.

5. The container and dispenser of claim 1, wherein the opposing wall hingedly attaches to the body.

6. The container and dispenser of claim 1, wherein a seal between at least one of the walls and the body is a seal selected from the group consisting of an induction seal, an adhesive seal and a plastic to plastic seal.

7. The container and dispenser of claim 1, which includes a member extending between the moveable wall and the opposing wall.

8. The container and dispenser of claim 1, wherein the pet food, pressurized when the consumer presses and moves the moveable wall, causes the opposing wall to be dislodged from the body.

9. The container and dispenser of claim 1, wherein the opposing wall is removable from and reseals to the body.

10. The container and dispenser of claim 1, which includes a plurality of compartments that separate a first pet food component from a second pet food component.

11. The container and dispenser of claim 1, wherein the opposing wall cannot translate through the interior of the body.

12. A pet food container and dispenser comprising:
a body defining an interior including a first opening at a first end and a second opening at a second end;
a first wall located within the interior and moveable in a first end to second end direction;
a second wall located within the interior and moveable in a second end to first end direction; and
a quantity of pet food maintained between the first and second moveable walls.

13. The container and dispenser of claim 12, which includes a first seal that covers and seals the first opening and a second seal that covers and seals the second opening.

14. The container and dispenser of claim 13, wherein the first and second seals are foils selected from the group consisting of a heat sealable foil and an induction foil.

15. The container and dispenser of claim 12, wherein the body is cylindrical.

16. The container and dispenser of claim 12, wherein the first and second walls slide against an inner surface of the body.

17. The container and dispenser of claim 12, wherein at least one of the first and second walls hingedly attaches to the body.

18. The container and dispenser of claim 12, wherein the first and second walls are cardboard.

19. The container and dispenser of claim 12, which includes a seal between the first wall and the body and a seal between the second wall and the body, wherein the seals are selected from a group consisting of an induction seal, an adhesive seal and a plastic to plastic seal.

20. The container and dispenser of claim 12, wherein the pet food is pressurized when one of the walls is pressed and moved, which causes an opposing wall to be dislodged from the body.

21. A pet food product comprising:
a nutritionally balanced meal located in a container having a body defining a first opening and a second opening and a wall that allows a consumer to move the wall and force the pet food out the first opening.

22. The pet food product of claim 21 wherein the meal is wet.

23. The pet food product of claim 21, wherein the meal includes a plurality of pet food components having different viscosities.

24. The pet food product of claim 21, wherein the meal includes a plurality of pet food components having different moisture contents.

25. A method for providing a pet food meal comprising the steps of:
providing a container including an end with a moveable wall, an end with an opposing wall and pet food maintained between the moveable wall and the opposing wall; and
pressing and moving the moveable wall so that a quantity of the pet food is dispensed from the container.

26. The method of claim 25, which includes removing the end wall and pressing and moving the moveable wall so that the moveable wall forces the quantity of first pet food from the container.

27. The method of claim 25, which includes pressing and moving the moveable wall and forcing the pet food to rupture a seal so that the pet food can be dispensed from the container.

28. The method of claim 25, wherein the pet food has a plurality of components, the multi-component pet food maintained between the moveable wall and the opposing wall so that pressing and moving the moveable wall forces the multi-component pet food from the container.

29. The method of claim 25, wherein the container defines a plurality of compartments that separate a plurality of pet food components, the compartments and components maintained between the moveable wall and the opposing wall, so that pressing and moving the moveable wall forces the components from the container.

30. A method for reducing a mess associated with dispensing a wet pet food meal comprising the steps of:
providing a wet pet food meal located in a container having a body defining a first opening and a second opening and a moveable wall that allows a consumer to force the wet pet food out of the first opening; and
without using an additional utensil, removing the wet pet food meal from the container by moving the moveable wall.

31. The method of claim 30, which includes packaging the container so that the consumer is informed to press the wet pet food in an upward direction and then rotate the container to dispense the wet pet food.

32. A pet food-dispensing container comprising a body defining an interior for containing pet food having first and second opposed ends, each of said ends defining an opening and the body including closure means at each end.

33. The container of claim 32 wherein the closure means comprises a moveable wall.

34. The container of claim 33 wherein the moveable wall is moveable into the container.

35. The container of claim 32 wherein the closure means comprises sealing means.
